(19) United States
(12) Patent Application Publication
(10) Pub. No.: US 2023/0100819 A1
(43) Pub. Date: Mar. 30, 2023

(54) INTERLOCK SYSTEM, METHOD, STORAGE MEDIUM, AND VEHICLE

(71) Applicant: TOYOTA JIDOSHA KABUSHIKI KAISHA, Toyota-shi (JP)

(72) Inventors: Taiki TAKEMOTO, Toyota-shi (JP); Wataru YOKOYAMA, Toyota-shi (JP)

(73) Assignee: TOYOTA JIDOSHA KABUSHIKI KAISHA, Toyota-shi (JP)

(21) Appl. No.: 17/823,626

(22) Filed: Aug. 31, 2022

(30) Foreign Application Priority Data
Sep. 28, 2021 (JP) 2021-158208

(51) Int. Cl. B60R 16/033

(52) U.S. Cl. CPC B60R 16/033

(57) ABSTRACT

An interlock system used in a high voltage system including a high voltage power supply in which a first voltage is a specified voltage and a plurality of high voltage system loads each connected to the high voltage power supply via a power supply line, the interlock system including: an acquisition unit that acquires information of a voltage applied to an own load from each of the high voltage system loads; and a control unit that controls a voltage of the power supply line, in which before activating the high voltage system, the control unit causes a second voltage lower than the first voltage to be output to the power supply line, and after the second voltage is output, when the acquisition unit has not acquired information that the second voltage is applied from all high voltage system loads, the control unit cancels activation of the high voltage system.

### CROSS-REFERENCE TO RELATED APPLICATION

This application claims priority to Japanese Patent Application No. 2021-158208 filed on Sep. 28, 2021, incorporated herein by reference in its entirety.

### BACKGROUND

### 1. Technical Field

The present disclosure relates to an interlock system used in a high voltage system including a high voltage power supply, and the like.

### 2. Description of Related Art

Japanese Unexamined Patent Application Publication No. 2016-068797 (JP 2016-068797 A) discloses an automobile power source device that is provided with a means for detecting a disconnection of a connector used for connecting a high voltage power supply and a plurality of high voltage system loads, and that performs a control of shutting off a relay for supplying electric power to a high voltage system load.

### SUMMARY

In the configuration of the automobile power supply device described in JP 2016-068797 A, it is necessary to provide a dedicated means for detecting a disconnection state of the connector for each high voltage system load, and a complication or scaling up of a detection circuit and an increase in cost are inevitable.

The present disclosure has been made in view of the above problems. An object of the disclosure is to provide an interlock system that is able to detect that there is a high voltage system load in which electric power is not supplied from a high voltage power supply due to a connector being disconnected and able to safely stop the high voltage system.

In order to solve the above issue, an aspect of the disclosed technology is an interlock system used in a high voltage system including a high voltage power supply in which a first voltage is a specified voltage and a plurality of high voltage system loads each connected to the high voltage power supply via a power supply line, the interlock system including: an acquisition unit that acquires information of a voltage applied to an own load from each of the high voltage system loads; and a control unit that controls a voltage of the power supply line, in which before activating the high voltage system, the control unit causes a second voltage lower than the first voltage to be output to the power supply line, and after the second voltage is output, when the acquisition unit has not acquired information that the second voltage is applied from all of the high voltage system loads, the control unit cancels activation of the high voltage system.

According to the interlock system or the like used in the high voltage system of the present disclosure, it is possible to detect that there is a high voltage system load to which electric power is not supplied from a high voltage power supply and safely stop the high voltage system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a high voltage system using an interlock system according to a first embodiment;

FIG. 2 is a process flowchart of a control executed by the interlock system according to the first embodiment;

FIG. 3 is a schematic configuration diagram of the high voltage system using the interlock system according to a second embodiment; and

FIG. 4 is a process flowchart of the control executed by the interlock system according to the second embodiment.

### DETAILED DESCRIPTION OF EMBODIMENTS

An interlock system (ILK) of the present disclosure checks in advance the possibility of a disconnection of a connector for connection using a low voltage that does not pose a risk of electric shock or the like, before a high voltage system is fully activated. As a result, it is possible to suppress a person who touches an exposed portion of a high voltage from which the connector is disconnected from receiving an electric shock. Hereinafter, an embodiment of the present disclosure will be described in detail with reference to the drawings.

### First Embodiment

Configuration

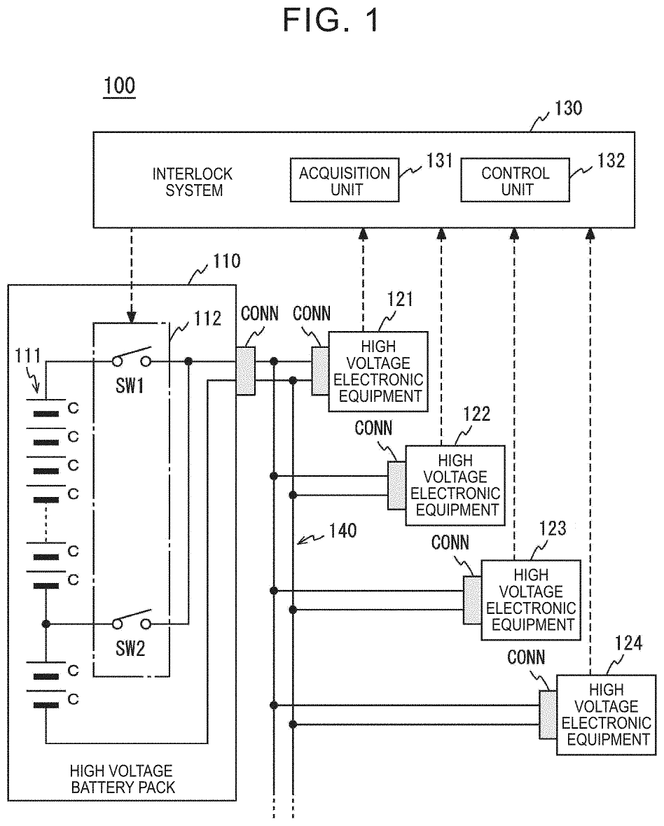

FIG. 1 is a schematic configuration diagram of a high voltage system using the interlock system according to the first embodiment of the present disclosure. A high voltage system 100 of the first embodiment illustrated in FIG. 1 includes a high voltage battery pack 110, a plurality of high voltage electronic equipment 121 to 124, and an interlock system 130. In FIG. 1, wiring (power supply line 140) through which electric power is transmitted and received is shown by a solid line, and wiring through which control instructions and detected values other than electric power are communicated is shown by a broken line. The high voltage system 100 can be mounted on an electrified vehicle such as a hybrid electric vehicle (HEV), a plug-in hybrid electric vehicle (PHEV), and a battery electric vehicle (BEV) that use an electric motor as a power source.

The high voltage battery pack 110 is a high voltage power source for supplying electric power to the plurality of high voltage electronic equipment 121 to 124. The high voltage battery pack 110 includes an assembled battery 111 configured by connecting a plurality of single battery cell C cells in series, and a switching unit 112 that can selectively switch which voltage to output as a voltage (output voltage of the high voltage battery pack 110) taken out from the assembled battery 111 based on an instruction from the interlock system 130.

As the single battery cell C, for example, a secondary battery such as a lithium ion battery configured to be chargeable and dischargeable is used. The switching unit 112 includes a switch SW1 that is turned on and causes conduction when causing a voltage (hereinafter referred to as a “first voltage”) when all of the single battery cells C of the assembled battery 111 are connected in series to be output, and a switch SW2 that is turned on and causes conduction when causing a voltage (hereinafter referred to as a “second voltage”) when all of the single battery cells C of the assembled battery 111 are connected in series to be output. The first voltage is a specified voltage (high voltage) of the high voltage battery pack 110, and the second voltage is a voltage (low voltage) lower than this specified voltage, and can be a voltage value (such as 10V) in which an influence on a human body such as electric shock can be suppressed, for example. The switching unit 112 controls an ON/OFF state of each of the switch SW1 and the switch SW2 based on the instruction from the interlock system 130.

The plurality of high voltage electronic equipment 121 to 124 are so-called high voltage system loads that operate by receiving electric power as a power source from the high voltage battery pack 110. The high voltage electronic equipment 121 to 124 are each connected to the high voltage battery pack 110 so that electric power can be transferred via the power supply line (power line) 140. Examples of the high voltage electronic equipment 121 to 124 include in-vehicle devices such as an inverter, an air compressor, a DCDC converter, and a water heater. For the power supply line 140, for example, a wire harness having a connector CONN for connection at the end of the wiring can be used.

The interlock system 130 can monitor and control the high voltage battery pack 110. The interlock system 130 may typically be configured as a part or all of an electronic control unit (ECU) including a processor, a memory, an input/output interface, and the like. The interlock system 130 (or an electronic control device including an interlock function (for example, a higher-level ECU)) of the present embodiment realizes each function of the acquisition unit 131 and the control unit 132 described below by a processor reading and executing a program stored in a memory.

The acquisition unit 131 acquires information on the voltage applied to the power supply input of the plurality of high voltage electronic equipment 121 to 124 (hereinafter referred to as “input voltage information”) from the high voltage electronic equipment 121 to 124, respectively. An existing in-vehicle network such as a controller area network (CAN) can be used to acquire the input voltage information. This input voltage information may be constantly acquired or may be acquired at a predetermined cycle. Further, the input voltage information may be acquired by the acquisition unit 131 requesting the input voltage information from each high voltage electronic equipment 121 to 124 (PUSH type), or may be acquired by each high voltage electronic equipment 121 to 124 notifying the acquisition unit 131 of the input voltage information at a predetermined timing (PULL type).

The control unit 132 controls the ON/OFF state of each of the switch SW1 and the switch SW2 in the switching unit 112 of the high voltage battery pack 110 based on an operating state (before activation/after activation) of the high voltage system 100 and the input voltage information acquired from each of the plurality of high voltage electronic equipment 121 to 124. The control performed by the control unit 132 will be described later.

Control

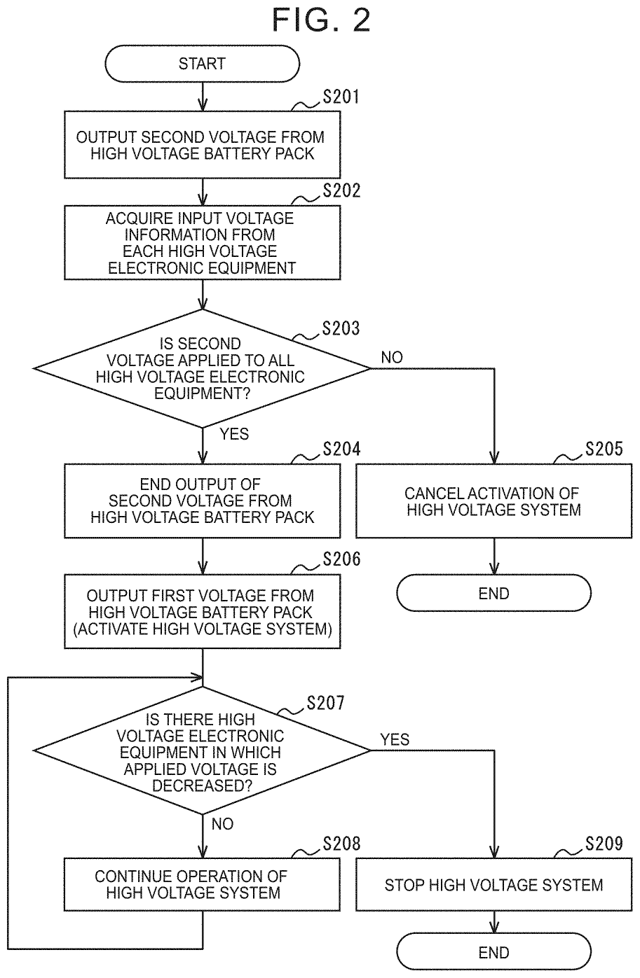

The control performed by the interlock system 130 according to the present first embodiment will be described with reference to FIG. 2. FIG. 2 is a flowchart illustrating a process procedure of the interlock control executed by the interlock system 130.

The interlock control shown in FIG. 2 is activated, for example, when an ignition switch of a vehicle is turned on (IG-ON) and the timing for activating and operating the high voltage system 100 comes.

Step S201

The control unit 132 of the interlock system 130 causes a second voltage lower than the specified voltage to be output from the high voltage battery pack 110 to the power supply line 140, as a pre-process for activating the high voltage system 100. The output of the second voltage can be achieved by controlling the switch SW1 to be in the OFF state (disconnection) and the switch SW2 to be in the ON state (conduction), in the switching unit 112 of the high voltage battery pack 110. When the second voltage is output to the power supply line 140, the process proceeds to step S202.

Step S202

The acquisition unit 131 of the interlock system 130 acquires the input voltage information, which is information on the voltage applied to the power supply input, from the plurality of high voltage electronic equipment 121 to 124, respectively. When the input voltage information of the plurality of high voltage electronic equipment 121 to 124 is acquired, the process proceeds to step S203.

Step S203

The control unit 132 of the interlock system 130 determines whether the second voltage is applied as a power supply input to all of the plurality of high voltage electronic equipment 121 to 124, based on the input voltage information acquired by the acquisition unit 131. When the second voltage is applied to all of the plurality of high voltage electronic equipment 121 to 124 (step S203, yes), the process proceeds to step S204. On the other hand, when the second voltage is not applied to even one of the plurality of high voltage electronic equipment 121 to 124 (step S203, no), the process proceeds to step S205.

Step S204

The control unit 132 of the interlock system 130 determines that an electric power supply failure due to the connector CONN being disconnected has not occurred to a part or all of the high voltage electronic equipment 121 to 124, and completes the process of causing the second voltage from the high voltage battery pack 110 to be output to the power supply line 140. The end of the output of the second voltage can be achieved by controlling both the switch SW1 and the switch SW2 to be in the OFF state (disconnection), in the switching unit 112 of the high voltage battery pack 110. When the output of the second voltage from the high voltage battery pack 110 to the power supply line 140 is completed, the process proceeds to step S206.

Step S205

The control unit 132 of the interlock system 130 determines that an electric power supply failure due to the connector CONN being disconnected has occurred for a part or all of the plurality of high voltage electronic equipment 121 to 124, and performs a process of stopping an activating process of the high voltage system 100. When the activation of the high voltage system 100 is stopped, the present interlock control is ended.

Step S206

The control unit 132 of the interlock system 130 causes the first voltage, which is the specified voltage (high voltage), to be output from the high voltage battery pack 110 to the power supply line 140. The output of the first voltage can be achieved by controlling the switch SW1 to be in the ON state (conduction) and the switch SW2 to be in the OFF state (disconnection), in the switching unit 112 of the high voltage battery pack 110. As a result, the high voltage system 100 is actually activated. When the first voltage is output to the power supply line 140, the process proceeds to step S207.

Step S207

The control unit 132 of the interlock system 130 determines whether there is a high voltage electronic device in which the voltage that is applied as a power supply input is decreased, among the plurality of high voltage electronic equipment 121 to 124, based on the input voltage information acquired by the acquisition unit 131. It is possible to determine that the applied voltage has decreased, for example, depending on whether the applied voltage becomes a third voltage or less, which is lower than the first voltage. This third voltage can be appropriately set based on an input-side open circuit voltage of the high voltage electronic equipment when the connector CONN is disconnected. When there is even one high voltage electronic device in which the applied voltage has decreased (step S207, yes), the process proceeds to step S209. On the other hand, when there is no high voltage electronic equipment in which the applied voltage has decreased (step S207, no), the process proceeds to step S208.

Step S208

The control unit 132 of the interlock system 130 determines that an electric power supply failure due to the connector CONN being disconnected has not occurred for a part or all of the plurality of high voltage electronic equipment 121 to 124, and continues operation of the high voltage system 100. The continuous operation of the high voltage system 100 is performed by continuing the process of causing the first voltage to be from the high voltage battery pack 110 to the power supply line 140. When the operation of the high voltage system 100 is continued, the process proceeds to step S207.

Step S209

The control unit 132 of the interlock system 130 determines that an electric power supply failure due to the connector CONN being disconnected has occurred for a part or all of the plurality of high voltage electronic equipment 121 to 124, and stops the high voltage system 100 that is being operated. When the high voltage system 100 is stopped, the present interlock control ends.

As in the interlock control of the first embodiment described above, before activating the high voltage system 100, in a state in which a low voltage (second voltage) is first applied instead of a high voltage (first voltage) being immediately applied from the high voltage battery pack 110, an occurrence of an electric power supply failure due to the connector CONN being disconnected for a part or all of the plurality of high voltage electronic equipment 121 to 124 is determined (process of steps S201 to S205). This makes it possible to suppress, for example, an unexpected situation from occurring in which a vehicle inspection worker or the like touches an exposed portion that has a high voltage and in which the connector CONN is disconnected, and receives an electric shock.

### Second Embodiment

Configuration

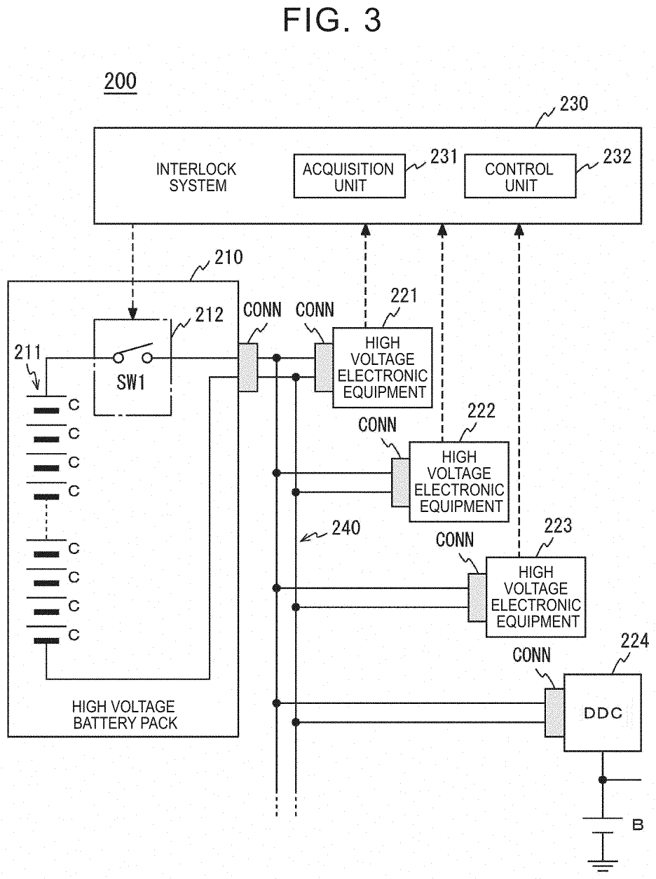

FIG. 3 is a schematic configuration diagram of the high voltage system using the interlock system according to the second embodiment of the present disclosure. A high voltage system 200 of the second embodiment illustrated in FIG. 3 includes a high voltage battery pack 210, a plurality of high voltage electronic equipment 221 to 224, and an interlock system 230. In FIG. 3, wiring (power supply line 140) through which electric power is transmitted and received is shown by a solid line, and wiring through which control instructions and detected values other than electric power are communicated is shown by a broken line. The high voltage system 200 can be mounted on an electrified vehicle such as a hybrid electric vehicle (HEV), a plug-in hybrid electric vehicle (PHEV), and a battery electric vehicle (BEV) that use an electric motor as a power source.

The high voltage battery pack 210 is a high voltage power source for supplying electric power to the plurality of high voltage electronic equipment 221 to 224. The high voltage battery pack 210 includes an assembled battery 211 configured by connecting a plurality of single battery cell C cells in series, and a switching unit 212 that can selectively switch whether to output a voltage (output voltage of the high voltage battery pack 110) of the assembled battery 211 based on an instruction from the interlock system 230.

As the single battery cell C, for example, a secondary battery such as a lithium ion battery configured to be chargeable and dischargeable is used. The switching unit 212 includes the switch SW1 that is turned on and causes conducts when causing a voltage (first voltage) when all of the single battery cells C of the assembled battery 211 are connected in series to be output. The first voltage is the specified voltage (high voltage) of the high voltage battery pack 210. The switching unit 212 controls the ON/OFF state of the switch SW1 based on the instruction from the interlock system 230.

The plurality of high voltage electronic equipment 221-224 are so-called high voltage system loads that operate by receiving electric power as a power source from the high voltage battery pack 210. The high voltage electronic equipment 221 to 224 are each connected to the high voltage battery pack 210 so that electric power can be transferred via a power supply line (power line) 240. Examples of the high voltage electronic equipment 221 to 223 include in-vehicle devices such as an inverter, an air compressor, and a water heater. The high voltage electronic equipment (DDC) 224 is a bidirectional DCDC converter that connects a storage battery having a specified voltage lower than that of the high voltage battery pack 210, for example, an auxiliary battery B, and a power supply line 240. The high voltage electronic equipment (DDC) 224 can convert (step down) the voltage input from the high voltage battery pack 210 into a predetermined voltage and output it to the auxiliary battery B. Further, the high voltage electronic equipment (DDC) 224 can convert (boost or step down) the voltage input from the auxiliary battery B into a predetermined voltage based on the instruction from the interlock system 230, and output the voltage to the power supply line 240. For the power supply line 240, for example, a wire harness having a connector CONN for connection at the end of the wiring can be used.

The interlock system 230 can monitor and control the high voltage battery pack 210. The interlock system 230 may typically be configured as a part or all of an electronic control unit (ECU) including a processor, a memory, an input/output interface, and the like. The interlock system 230 (or an electronic control device including an interlock function (for example, a higher-level ECU)) of the present embodiment realizes each function of an acquisition unit 231 and a control unit 232 described below by a processor reading and executing a program stored in a memory.

The acquisition unit 231 acquires, from the high voltage electronic equipment 221 to 223, information (input voltage information) of the voltage applied to the power supply input of the high voltage electronic equipment 221 to 223, respectively. An existing in-vehicle network such as CAN can be used to acquire the input voltage information. This input voltage information may be constantly acquired or may be acquired at a predetermined cycle. Further, the input voltage information may be acquired by the acquisition unit 231 requesting the input voltage information from each high voltage electronic equipment 221 to 223 (PUSH type), or may be acquired by each high voltage electronic equipment 221 to 223 notifying the acquisition unit 231 of the input voltage information at a predetermined timing (PULL type).

The control unit 232 controls the ON/OFF state of the switch SW1 in the switching unit 112 of the high voltage battery pack 210 based on an operating state (before activation/after activation) of the high voltage system 200 and the input voltage information acquired from each of the plurality of high voltage electronic equipment 221 to 223. The control performed by the control unit 232 will be described later.

Control

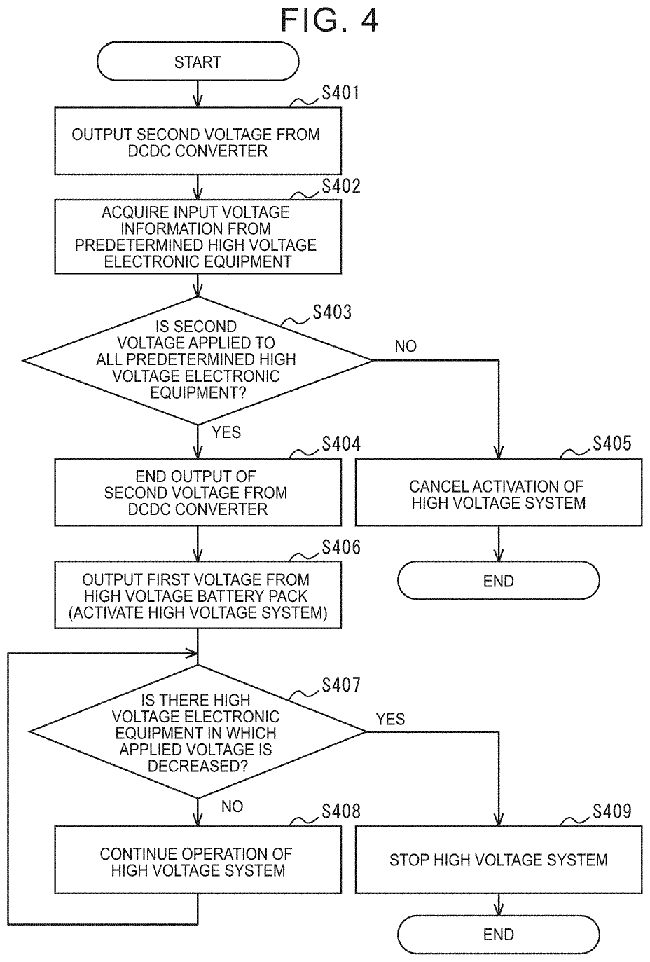

The control performed by the interlock system 230 according to the present second embodiment will be described with reference to FIG. 4. FIG. 4 is a flowchart illustrating a process procedure of the interlock control executed by the interlock system 230.

The interlock control shown in FIG. 4 is activated, for example, when an ignition switch of a vehicle is turned on (IG-ON) and the timing for activating and operating the high voltage system 200 comes.

Step S401

The control unit 232 of the interlock system 230 causes a second voltage lower than the specified voltage to be output from the auxiliary battery B to the power supply line 240 via the high voltage electronic equipment (DDC) 224, as a pretreatment for activating the high voltage system 200. While the second voltage is being output from the auxiliary battery B, the switch SW1 of the switching unit 112 of the high voltage battery pack 110 is controlled to the OFF state (disconnection). When the second voltage is output to the power supply line 240, the process proceeds to step S402.

Step S402

The acquisition unit 231 of the interlock system 230 acquires input voltage information, which is information of the voltage applied to the power supply input, from the predetermined high voltage electronic equipment 221 to 223 excluding the high voltage electronic equipment (DDC) 224. When the input voltage information of the predetermined high voltage electronic equipment 221 to 223 is acquired, the process proceeds to step S403.

Step S403

The control unit 232 of the interlock system 230 determines whether the second voltage is applied as the power supply input to all of the predetermined high voltage electronic equipment 221 to 223 based on the input voltage information acquired by the acquisition unit 231. When the second voltage is applied to all of the predetermined high voltage electronic equipment 221 to 223 (step S403, yes), the process proceeds to step S404. On the other hand, when the second voltage is not applied to any one of the predetermined high voltage electronic equipment 221 to 223 (step S403, no), the process proceeds to step S405.

Step S404

The control unit 232 of the interlock system 230 determines that an electric power supply failure has not occurred for a part or all of the high voltage electronic equipment 221 to 223 as a result of the connector CONN being disconnected, and ends the process of causing the second voltage to be output from the auxiliary battery B to the power supply line 240 via the high voltage electronic equipment (DDC) 224. The end of the output of this second voltage is possible by stopping the operation of the high voltage electronic equipment (DDC) 224. When the output of the second voltage from the auxiliary battery B to the power supply line 240 is completed, the process proceeds to step S406.

Step S405

The control unit 232 of the interlock system 230 determines that an electric power supply failure due to the connector CONN being disconnected has occurred for a part or all of the predetermined of high voltage electronic equipment 221 to 223, and performs a process of stopping an activating process of the high voltage system 200. When the activation of the high voltage system 200 is canceled, this interlock control ends.

Step S406

The control unit 232 of the interlock system 230 causes the first voltage, which is the specified voltage (high voltage), to be output from the high voltage battery pack 210 to the power supply line 240. The output of the first voltage can be achieved by controlling the switch SW1 to be in the ON state (conduction), in the switching unit 212 of the high voltage battery pack 210. As a result, the high voltage system 200 is actually activated. When the first voltage is output to the power supply line 240, the process proceeds to step S407.

Step S407

The control unit 232 of the interlock system 230 determines whether there is a high voltage electronic device in which the voltage that is applied as a power supply input is decreased, among the predetermined high voltage electronic equipment 221 to 223, based on the input voltage information acquired by the acquisition unit 231. It is possible to determine that the applied voltage has decreased, for example, depending on whether the applied voltage becomes the third voltage or less, which is lower than the first voltage. This third voltage can be appropriately set based on the input-side open circuit voltage of the high voltage electronic equipment when the connector CONN is disconnected. When there is even one high voltage electronic equipment in which the applied voltage has decreased (step S407, yes), the process proceeds to step S409. On the other hand, when there is no high voltage electronic equipment in which the applied voltage has decreased (step S407, no), the process proceeds to step S408.

Step S408

The control unit 232 of the interlock system 230 determines that an electric power supply failure due to the connector CONN being disconnected has not occurred for a part or all of the predetermined high voltage electronic equipment 221 to 223, and continues operation of the high voltage system 200. The continuous operation of the high voltage system 200 is performed by continuing the process of outputting the first voltage from the high voltage battery pack 210 to the power supply line 240. When the operation of the high voltage system 200 is continued, the process proceeds to step S407.

Step S409

The control unit 232 of the interlock system 230 determines that an electric power supply failure due to the connector CONN being disconnected has occurred for a part or all of the predetermined high voltage electronic equipment 221 to 223, and stops the high voltage system 200 that is being operated. When the high voltage system 200 is stopped, the present interlock control ends.

As in the interlock control of the second embodiment described above, before activating the high voltage system 200, in a state in which the low voltage (second voltage) is first applied from the auxiliary battery B via the high voltage electronic equipment (DDC) 224 instead of the high voltage (first voltage) being immediately applied from the high voltage battery pack 210, an occurrence of an electric power supply failure due to the connector CONN being disconnected for a part or all of the predetermined high voltage electronic equipment 221 to 223 is determined (process of steps S401 to S405). This makes it possible to suppress, for example, an unexpected situation from occurring in which a vehicle inspection worker or the like touches an exposed portion that has a high voltage and in which the connector CONN is disconnected, and receives an electric shock.

In the interlock control of the second embodiment, when it is determined in step S403 that the second voltage is not applied to all of the predetermined high voltage electronic equipment 221 to 223, it is possible to conclude that some kind of electric power supply failure is occurring in the high voltage electronic equipment (DDC) 224.

Operations and Effects

As described above, before activating the high voltage system, the interlock system according to each embodiment of the present disclosure checks a possibility of a disconnection of the connector for connecting due to a pre-drive of the high voltage system by the low voltage (for example, a voltage that does not pose a risk of electric shock, etc.) supplied from the high voltage battery pack or from the auxiliary battery via the DCDC converter. By this control, it is possible to detect that there is a high voltage system load in which electric power is not supplied from the high voltage power supply due to disconnection of the connection connector or the like, without providing a dedicated detection means. Thus, even when the operator or the like touches the exposed portion where the connector for connection is disconnected during an inspection of the vehicle, the voltage applied to the exposed portion is low. Thus, the operator or the like can be suppressed from receiving an electric shock.

Further, in the interlock system according to each embodiment of the present disclosure, when it is detected that the normal voltage (high voltage) is no longer applied to any of the high voltage electronic equipment after the high voltage system is actually activated, the high voltage system is immediately stopped. This control can suppress the operator or the like from getting an electric shock even while the high voltage system is being activated.

Although one embodiment of the technique of the present disclosure has been described above, the present disclosure can be interpreted as a method executed by an interlock system including a processor and a memory, a control program of the method, a computer-readable, non-transitory storage medium that stores the control program, or a vehicle on which the interlock system is mounted, for example, in addition to the interlock system.

The interlock system of the present disclosure can be used for a high voltage system including a high voltage power supply mounted on a vehicle and a plurality of high voltage system loads.

What is claimed is:

1. An interlock system used in a high voltage system including a high voltage power supply in which a first voltage is a specified voltage and a plurality of high voltage system loads each connected to the high voltage power supply via a power supply line, the interlock system comprising:
an acquisition unit that acquires information of a voltage applied to an own load from each of the high voltage system loads; and
a control unit that controls a voltage of the power supply line,
wherein before activating the high voltage system, the control unit causes a second voltage lower than the first voltage to be output to the power supply line, and after the second voltage is output, when the acquisition unit has not acquired information that the second voltage is applied from all of the high voltage system loads, the control unit cancels activation of the high voltage system.

2. The interlock system according to claim 1, wherein before activating the high voltage system, the control unit causes the second voltage to be output to the power supply line, and after the second voltage is output, when the acquisition unit acquires information that the second voltage is applied from all of the high voltage system loads, the control unit causes the first voltage to be output from the high voltage power supply to the power supply line to activate the high voltage system.

3. The interlock system according to claim 2, wherein after activating the high voltage system, when the acquisition unit acquires information that a third voltage lower than the first voltage is applied from at least one of the high voltage system loads, the control unit cuts off output of the first voltage from the high voltage power supply to the power supply line and stops the high voltage system.

4. The interlock system according to claim 1,
wherein the high voltage power supply includes a switching unit that is able to switch an output voltage between the first voltage and the second voltage, and
wherein the control unit causes the second voltage to be output from the high voltage power supply to the power supply line.

5. The interlock system according to claim 1,
wherein the high voltage system further includes a DCDC converter that is bidirectional and that connects the power supply line and an auxiliary battery having a specified voltage lower than that of the high voltage power supply, and
wherein the control unit causes the second voltage to be output from the auxiliary battery to the power supply line via the DCDC converter.

6. A method executed by a computer of an interlock system used in a high voltage system including a high voltage power supply in which a first voltage is a specified voltage and a plurality of high voltage system loads each connected to the high voltage power supply via a power supply line, the method comprising:
a first step of causing a second voltage lower than the first voltage to be output to the power supply line before activating the high voltage system;
a second step of acquiring information of a voltage applied to an own load, from each of the high voltage system loads, after the first step; and
a third step of canceling activation of the high voltage system when information that the second voltage is applied is not acquired from all of the high voltage system loads in the second step.

7. A non-transitory storage medium that stores a program that is executed by a computer of an interlock system used in a high voltage system including a high voltage power supply in which a first voltage is a specified voltage and a plurality of high voltage system loads each connected to the high voltage power supply via a power supply line, the program comprising:
a first step of causing a second voltage lower than the first voltage to be output to the power supply line before activating the high voltage system;
a second step of acquiring information of a voltage applied to an own load, from each of the high voltage system loads, after the first step; and
a third step of canceling activation of the high voltage system when information that the second voltage is applied is not acquired from all of the high voltage system loads in the second step.

8. A vehicle in which the interlock system according to claim 1 is mounted.
